(19) United States
(12) Patent Application Publication
(10) Pub. No.: US 2004/0192248 A1
(43) Pub. Date: Sep. 30, 2004

(54) Shared device, system and method for multiple communication connections thereof

(76) Inventor: Meng-Kai Chen, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/821,768

(22) Filed: Apr. 9, 2004

(30) Foreign Application Priority Data
Aug. 5, 2002 (TW) 91117556

(51) Int. Cl. H04L 12/16

(52) U.S. Cl. 455/344; 455/130

(57) ABSTRACT

The present invention provides a shared device, a system and method thereof for multiple communications. The shared device connects a telephone receiver, a telephone, and a computer. The telephone receiver of the present invention can be used to make phone calls as well as replace the conventional microphone and speaker disposed in a computer for video conference. Furthermore, the telephone receiver connected to the shared device serves as the microphone and speaker of the computer, and is simultaneously capable of making a phone call to another participant to join the communication.

### BACKGROUND OF THE INVENTION

1. Field of the Invention

The present invention relates to a shared device for a telephone receiver, and more specifically, to a shared device connecting a telephone receiver, a telephone, and a computer, and a system and method of multiple communication connections using the shared device.

2. Description of the Related Art

Multimedia communication and Internet video conference has become very common, and it is necessary to mount microphones and speakers in the connected computers for transmitting and receiving voice data. Microphones and speakers are not necessities of the computers for most office workers although the cost is low, and moreover, these equipments occupy additional space in the computers and in work area. Since the telephone is a ubiquitous office tool, the cost of microphone and speaker can be eliminated if they are replaced by the telephone receiver in multimedia communication and video conference.

Additionally, the participants in a video conference must have a computer with internet access to join the conference. Thus a user without a computer or video conference device is unable to join. Therefore, taking part in a video conference is impossible for the users without the necessary equipment.

### SUMMARY OF THE INVENTION

Accordingly, the present invention provides a shared device for connecting a telephone receiver, a telephone, and a computer, enabling the telephone receiver not only as a receiver of telephone, but also as the microphone and speaker of the computer in a video conference if the shared device is connected thereof. When a telephone receiver is used in the multiple communication or in the video conference through the shared device, the telephone receiver may also be used to make phone call to another participant who cannot access to a computer or a video conference device, thus enabling this participant to join the multiple communication or the video conference without the necessary equipment.

The object of the present invention is to provide a shared device for connecting a telephone receiver, a telephone, and a computer, thus the telephone receiver is capable of receiving and sounding voice from the computer through the shared device instead of the microphone and speaker, as a result, the need for separate devices is eliminate, and reducing cost and space thereby.

Another object of the present invention is to provide a system and method for multiple communication connections using the shared device. In the multimedia communication or video conference, the telephone receiver connected to the shared device serves as the microphone and speaker of the computer, and is simultaneously capable of making a phone call to allow another phone user to join the communication.

The shared device of the present invention connects to a computer, a telephone, and a telephone receiver, and comprises a voice divider and a mixer. The voice divider receives a first voice signal from the computer, a second voice signal from the telephone, and a third voice signal from the telephone receiver, and divides the first voice signal into two first voice divided signals, the second voice signal into two second voice divided signals, and the third voice signal into two third voice divided signals. The mixer receives the voice divided signals, mixes a first and a second voice divided signal and transmits the mixed signal to the telephone receiver, mixes the other first and a third voice divided signal and transmits the mixed signal to the telephone, and mixes the other second and the other third voice divided signal and transmits the mixed signal to the computer.

The shared device further comprises an amplifier for amplifying the voice signal before further transmission, and an impedance match for adjusting the volume and voice-frequency of the first voice signal to be equivalent to the second and third voice signals according to the differential impedance between the computer and the telephone.

The present invention further provides a multiple communication system by using the shared device of the present invention. The multiple communication system comprises a computer, a telephone, a telephone receiver, and a shared device. The computer communicates with at least one remote Internet client through a communication network, and receives a first voice signal from the remote Internet client. The communication network composes of at least one of the Internet, a local area network, and a dedicated line. The telephone communicates with a remote telephone through a telephone network, and receives a second voice signal from the remote telephone. The telephone receiver connects with the computer and the telephone through the shared device, and receives a third voice signal from a user of the telephone receiver. The shared device comprises a voice divider and a mixer, wherein the voice divider receives the first voice signal from the computer, the second voice signal from the telephone, and the third voice signal from the telephone receiver, and divides the first voice signal into two first voice divided signals, the second voice signal into two second voice divided signals, and the third voice signal into two third voice divided signals. The mixer receives the voice divided signals, mixes a first and a second voice divided signal then transmit the mixed signal to the telephone receiver, mixes the other first and a third voice divided signal then transmit the mixed signal to the telephone, and mixes the other second and the other third voice divided signal then transmit the mixed signal to the computer.

The present invention also provides a multiple communication method by using the shared device described above. The multiple communication method comprises the step of: providing a computer for communication with at least a remote Internet client through a communication network, wherein the communication network comprises at least one of an Internet connection, a local area network, and a leased line; providing a telephone for communicating with a remote telephone used by a remote telephone user through a telephone network; providing a telephone receiver for being used by the telephone receiver user; and providing a shared device for connecting to the computer, the telephone, and the telephone receiver, wherein the shared device comprises a voice divider and a mixer for receiving voice signals from three parties: the remote Internet client, the remote telephone user, and the telephone receiver user, then mixing the voice signals from any two parties and transmitting to the third party in order to establish multiple communication connection between the remote Internet client, the remote telephone user, and the telephone receiver user.

### BRIEF DESCRIPTION OF THE DRAWINGS

The present invention can be more fully understood by reading the subsequent detailed description in conjunction with the examples and references made to the accompanying drawings, wherein:

FIG. 1 illustrates the system configuration of a multiple communication connections according to the present invention;

FIG. 2 illustrates the configuration of the shared device according to the first embodiment of the present invention;

FIG. 3 illustrates the configuration of the shared device according to the second embodiment of the present invention;

FIG. 4 illustrates the configuration of the shared device according to the third embodiment of the present invention.

### DETAILED DESCRIPTION OF THE INVENTION

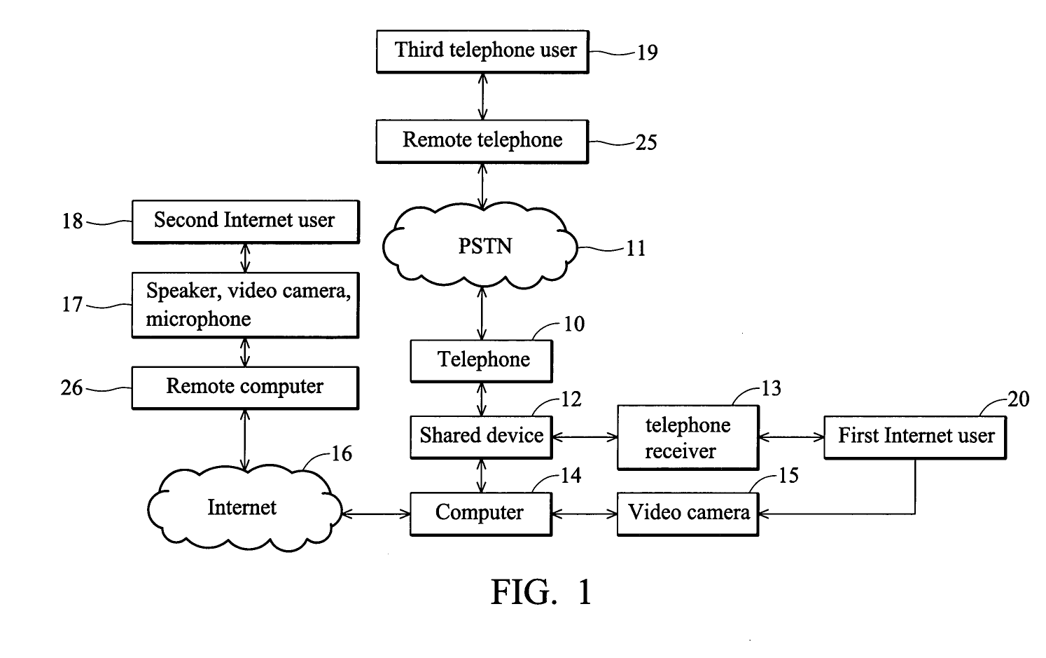

FIG. 1 illustrates a structure of the multiple communication system according to the embodiment of the present invention. As shown in FIG. 1, a shared device 12 is connected to a computer 14, a telephone 10, and a telephone receiver 13. The computer 14 communicates with another remote computer 26 through the Internet 16. The computer 14 connects a video camera for recording video images and a telephone receiver 13 by the shared device 12 for receiving and sending voice, and conducts an Internet video conference between the first Internet user 20 and the second Internet user 18. At the same time, the first Internet user 20 connects with a third telephone user 19 via the telephone 10, the Public Switch Telephone Network (PSTN) 11, and the remote telephone 25 for voice communication. The first Internet user 20, the second Internet user 18, and the third telephone user 12 conduct voice communication simultaneously through the shared device 12 in the Internet video conference. If the second Internet user 18 has a shared device, a telephone and a telephone receiver connected to the remote computer 26 like the first Internet user 20, another telephone user can join the communication via PSTN as described above.

Furthermore, the Internet video conference involves at least two members. All members of the video conference can send voice to the first Internet user 20, and then transmit voice to the third telephone user 19 by the shared device 12 and the PSTN 11. Similarly, the third telephone user 19 sends voice to the first Internet user 20 by the remote telephone 25 and PSTN 11, and then broadcasts to all members of the video conference. Accordingly, the third telephone user 19 is able to join the Internet conference call without accessing to a computer, conference device and Internet.

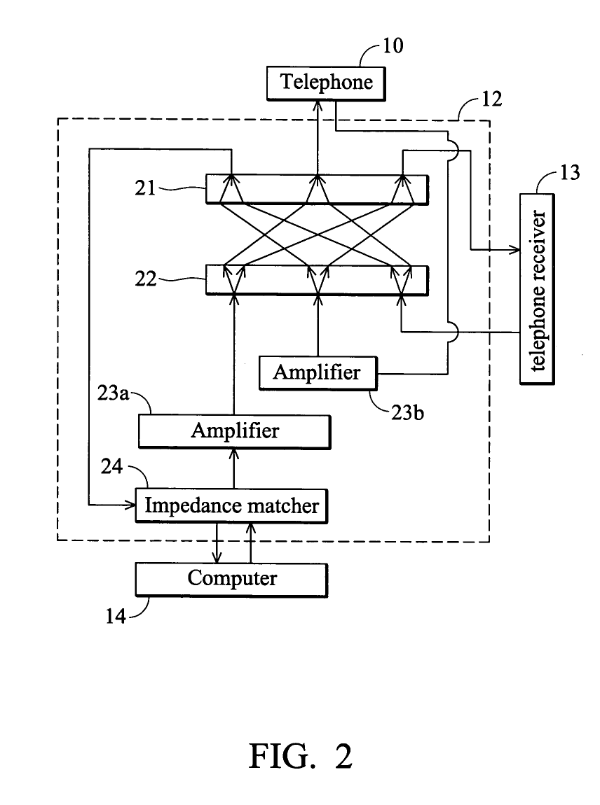

FIG. 2 is a diagram illustrating the structure of the shared device according to the first embodiment of the present invention. The shared device 12 mainly comprises a mixer 21 and a voice divider 22. The voice divider 22 receives a first voice signal from the computer 14, a second voice signal from the telephone 10, and a third voice signal from the telephone receiver 13 individually. The voice divider 22 divides each received signal into two voice divided signals which are sent to the mixer 21. The mixer 21 receives the voice divided signals from the voice divider 22, mixes a first voice divided signal from the computer 14 and a second voice divided signal from the telephone 10, and then transmits the mixed signal to the telephone receiver 13. The mixer 21 also mixes the other first voice divided signal from the computer 14 and a third voice divided signal from the telephone receiver 13 then transmits the mixed signal to the telephone 10, as well as mixes the other second voice divided signal from the telephone 10 and the other third voice divided signal from the telephone receiver 13 then transmits the mixed new signal to the computer 14. That is to say, the voice divider 22 receives the voice signals from the computer 14, telephone 10, and telephone receiver 13, divides each voice signal into two output signals, and transmits them individually to the mixer 21. The mixer 21 receives and mixes any two voice divided signals originally from two different parties out of the telephone 10, computer 14, and telephone receiver 13, then transmits to the third party, thus enabling the third party to hear the other two parties.

The voice divider 22 and the mixer 21 of the present system can be composed by electronic components disposed on a circuit board. Although the digital signal transmitted through the Internet is different from the analog signal transmitted via PSTN, the digital signal can be converted to analog signal by a sound card in the computer, and the telephone 10 is capable of communicating with Internet users through the present system.

The voice signals transmitted from the third telephone user 19 and the second Internet user 18 degrade when transmitting to the telephone 10 or computer 14 via PSTN 11 or Internet 16. Therefore, the shared device 12 further comprises two amplifiers for amplifying the voice signals before transmitting to the voice divider 22. As shown in FIG. 2, the voice signal from the telephone 10 is fed into amplifier 23b, and the voice signal from the computer 14 is fed into amplifier 23a. The amplified voice signals are then sent to the voice divider 22.

Since the impedance of the computer 14 and the telephone 10 is different from the impedance of the telephone receiver 13, if the volume and frequency of the input voice does not match others, the voice signals from the computer and the telephone will be distorted after the dividing and mixing processes performed by the voice divider 22 and the mixer 21. Accordingly, the shared device 12 further comprises an impedance matcher 24 for adjusting the volume and voice-frequency of the voice signals from the computer 14 according to the differential impedance between the computer and the telephone. The adjusted voice signal that is equivalent as the signal of the telephone 10 is then transmitted to the amplifier and the voice divider 22.

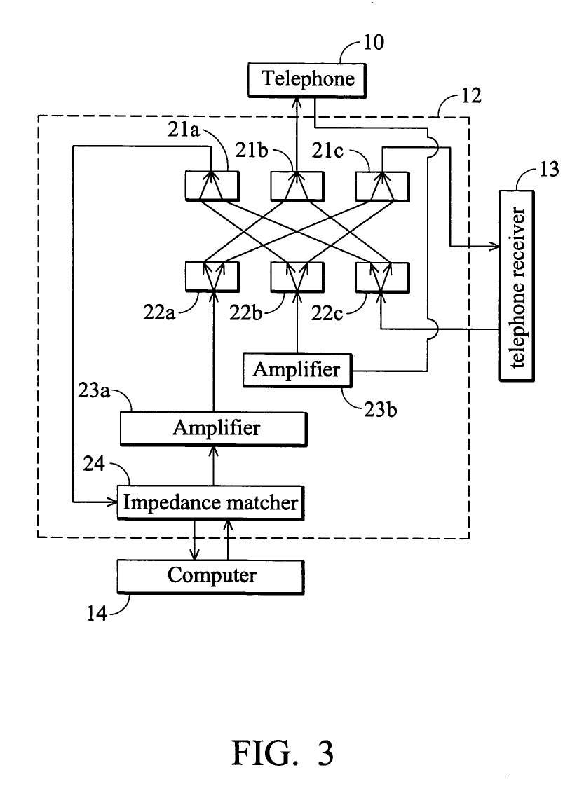

FIG. 3 is a diagram illustrating the structure of the shared device according to the second embodiment of the present invention. The shared device 12 mainly comprises three mixers 21a, 21b, and 21c, and three voice dividers 22a, 22b, and 22c. The voice divider 22a receives and divides a first voice signal from the computer 14 into two first voice divided signals, then sends the two divided signals to the mixers 21b and 21c individually. The mixer 22b receives a second voice signal from the telephone 10, and divides into two divided signals for each of the mixers 21a and 21c. Similarly, the mixer 22c receives a third voice signal from the telephone receiver 13, and divides into two divided signals for each of the mixers 21a and 21b. The mixer 21a receives and mixes the divided signals from the voice dividers 22b and 22c, and subsequently transmits the mixed signal to the computer 14. The mixer 21b receives and mixes the divided signals from the voice dividers 22a and 22c, and subsequently transmits the mixed signal to the telephone 10. The mixer 21c receives and mixes the divided signals from the voice dividers 22a and 22b, and subsequently transmits the mixed signal to the telephone receiver 13.

The shared device 12 can further comprise two amplifiers 22a and 22b and an impedance match 24 as previously mentioned, wherein the functionality and characteristics of the amplifiers and impedance matching are identical with the first embodiment.

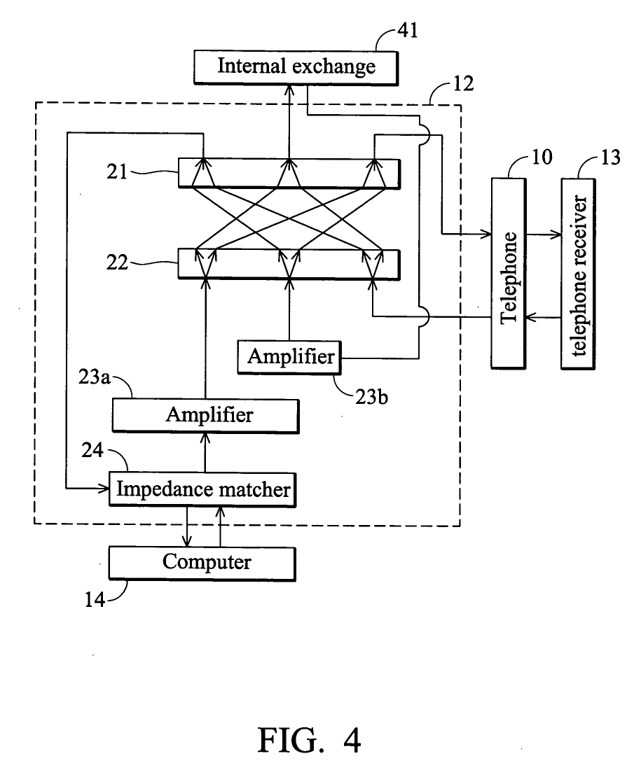

FIG. 4 is a diagram illustrating the structure of the shared device according to the third embodiment of the present invention. The technical features of shared device 12 in the present embodiment are identical to the first embodiment. The difference between the two embodiments is that the shared device 12 of the present embodiment connects to the computer 14, telephone 10, and an internal telephone exchange 41. The signals from different standard telephone exchanges are different, thus the mixer and the voice divider must be designed to match the telephone exchange 41. The impedance matcher 24 must also be adjusted according to the impedances of the computer 14 and the telephone exchange 41.

A typical video conference requires all conference participants to access the Internet through an Internet terminal; hence, participants cannot join the conference via the PSTN and telephone. A telephone receiver of the telephone can be used to replace the speaker and microphone for the video conference, whereas another telephone user can also join the conference through the shared device.

The multiple communication system provided in the present invention mainly comprises a telephone 10, a telephone receiver 13, a computer 14, and a shared device 12. The shared device 12 connects the three parties: telephone 10, telephone receiver 13, and the computer 14, wherein the first Internet user 20 uses the telephone receiver 13 as the microphone and speaker, and uses video camera to record the image of the user 20 for video conference with the second Internet user 18 through the shared device 12, computer 14, Internet 16, and remote computer 26. The second Internet user 18 uses a video camera, microphone, and speaker to transmit image and voice with the first Internet user 20. At the same time, the first Internet user 20 uses the telephone receiver 13, telephone 10, and the shared device 12 to make a phone call with the remote third telephone user 19 through the PSTN 11 and remote telephone 25. Multiple voice communication connection can thus be established for the first Internet user 20, second Internet user 18, and third telephone user 19 through the Internet 16 and PSTN 11.

The method for applying the shared device for multiple communication connections is described in the following.

In Step 501, a computer 14 is provided for communication with a remote computer 26 operated by the remote second Internet user 18 via the Internet 16.

In Step 502, a telephone 10 is provided for communication with a remote telephone 25 operated by the remote third telephone user through the PSTN 11.

In Step 503, a telephone receiver 13 is provided for the first Internet user 20.

In Step 504, the computer 14, telephone 10, and the telephone receiver 13 are connected to a shared device 12. The shared device 12 receives the voice signals from the computer of the second Internet user 18, telephone of the third telephone user 19, and the telephone receiver of the first Internet user 20, mixes any two of the voice signals received from two different parties and then transmits the signals to the other party.

The video conference described in the present invention is typically conducted through the Internet, local networks, leased lines, TV cables, wireless communication networks, or a communication network comprising any combination of the above. The embodiments of the present invention give an example of communication through the Internet; however, the present invention is not limited by the proposed embodiments.

The shared device proposed by the present invention provides the following advantages. The existing telephone is used for transmitting voice in the video conference through the computer and Internet, as a result, the hardware cost for setting up a video conference is reduced. The telephone receiver can be used in the video conference like a microphone and speaker; hence the speaker and microphone can be eliminated.

The users may be participated in the video conference by simply using the telephone receiver, which ameliorates disadvantages of using the microphone and speaker in the office, such as weak reception, and the volume of the speaker.

The shared device allows people without Internet conference software and related equipments to participate in the video conference through the telephone, PSTN, and the shared device according to the present invention.

Finally, while the invention has been described by way of examples and in terms of the above, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A shared device for connecting a computer, a telephone, and a telephone receiver, comprising:
a voice divider, for receiving a first voice signal from the computer, a second voice signal from the telephone, and a third voice signal from the telephone receiver, and dividing the first voice signal into two first voice divided signals, the second voice signal into two second voice divided signals, and the third voice signal into two third voice divided signals; and
a mixer, for receiving the voice divided signals, mixing a first and a second voice divided signal then transmitting the mixed signal to the telephone receiver, mixing the other first and a third voice divided signal then transmitting the mixed signal to the telephone, and mixing the other second and the other third voice divided signal then transmitting the mixed signal to the computer.

2. The shared device according to claim 1, further comprising a first amplifier, disposed between the computer and the voice divider for amplifying the first voice signal before sending it to the voice divider.

3. The shared device according to claim 2, further comprising an impedance matcher, disposed between the first amplifier and the computer for adjusting the volume and voice-frequency of the voice signal from the computer according to a differential impedance between the computer and the telephone.

4. The shared device according to claim 3, further comprising a second amplifier, disposed between the telephone and the voice divider for amplifying the second voice signal before sending it to the voice divider.

5. The shared device according to claim 1, further comprising an amplifier, disposed in between the telephone and the voice divider for amplifying the second voice signal before sending it to the voice divider.

6. A shared device for connecting a computer, a telephone, and a telephone receiver, comprising:
three voice dividers, wherein a first voice divider receives a first voice signal from the computer then divides it into two first voice divided signals, a second voice divider receives a second voice signal from the telephone then divides it into two second voice divided signals, a third voice divider receives a third voice signal from the telephone receiver then divides it into two third voice divided signals, and
three mixers, wherein a first mixer receives and mixes a first and a second voice divided signal then sends the mixed signal to the telephone receiver, a second mixer receives and mixes the other first and a third voice divided signal then sends the mixed signal to the telephone, and a third mixer receives and mixes the other second and the other third voice divided signal then sends the mixed signal to the computer.

7. The shared device according to claim 6, further comprising a first amplifier, disposed between the computer and the first voice divider for amplifying the first voice signal before sending it to the first voice divider.

8. The shared device according to claim 7, further comprising an impedance matcher, disposed between the first amplifier and the computer for adjusting the volume and voice-frequency of the voice signal from the computer according to a differential impedance between the computer and the telephone.

9. The shared device according to claim 8, further comprising a second amplifier, disposed between the telephone and the second voice divider for amplifying the second voice signal before sends it to the second voice divider.

10. The shared device according to claim 6, further comprising an amplifier, disposed between the telephone and the second voice divider for amplifying the second voice signal before sends it to the second voice divider.

11. A shared device for connecting a computer, a telephone, and an internal phone exchanger, comprising:
a voice divider, for receiving a first voice signal from the computer, a second voice signal from the telephone, and a third voice signal from the internal phone exchange, and dividing the first voice signal into two first voice divided signals, the second voice signal into two second voice divided signals, and the third voice signal into two third voice divided signals; and
a mixer, for receiving the voice divided signals, mixing a first and a second voice divided signal then transmitting the mixed signal to the internal phone exchange, mixing the other first and a third voice divided signal then transmitting the mixed signal to the telephone, and mixing the other second and the other third voice divided signal then transmitting the mixed signal to the computer.

12. The shared device according to claim 11, further comprising a first amplifier, disposed between the computer and the voice divider for amplifying the first voice signal before sends it to the voice divider.

13. The shared device according to claim 12, further comprising an impedance matcher, disposed between the first amplifier and the computer for adjusting the volume and voice-frequency of the voice signals from the computer according to a differential impedance between the computer and the telephone.

14. The shared device according to claim 13, further comprising a second amplifier, disposed between the internal phone exchanger and the voice divider for amplifying the second voice signal before sending it to the voice divider.

15. The shared device according to claim 11, further comprising an amplifier, disposed between the telephone and the voice divider for amplifying the second voice signal before sending it to the voice divider.

16. A multiple communication system, comprising:
a computer, communicating with at least one remote Internet client through a communication network, receiving a first voice signal from the remote Internet client, wherein the communication network composed of at least one of the Internet, a local area network, and a leased line;
a telephone, communicating with a remote telephone through a telephone network, receiving a second voice signal from the remote telephone;
a telephone receiver, receiving a third voice signal from the telephone receiver user; and
a shared device, connecting the computer, the telephone, and the telephone receiver, comprising a voice divider and a mixer, wherein the voice divider receives the first voice signal from the computer, the second voice signal from the telephone, and the third voice signal from the telephone receiver, and divides the first voice signal into two first voice divided signals, the second voice signal into two second voice divided signals, and the third voice signal into two third voice divided signals, and the mixer receives the voice divided signals, mixes a first and a second voice divided signal then sends the mixed signal to the telephone receiver, mixes the other first and a third voice divided signal then sends the mixed signal to the telephone, and mixes the other second and the other third voice divided signal then sends the mixed signal to the computer.

17. The multiple communication system according to claim 16, wherein the shared device further comprising:
a first amplifier, disposed between the computer and the voice divider for amplifying the first voice signal before sending it to the voice divider;
a second amplifier, disposed between the telephone and the voice divider for amplifying the second voice signal before sending it to the voice divider; and
an impedance match, disposed between the first amplifier and the computer for adjusting the volume and voice-frequency of the voice signal from the computer according to a differential impedance between the computer and the telephone.

18. The multiple communication system according to claim 16, further comprising a video camera installed in the computer for recording and sending the video of the telephone receiver user to the remote Internet client.

19. A multiple communication system, comprising:
a computer, communicating with at least one remote Internet client through a communication network, receiving a first voice signal from the remote Internet client, wherein the communication network composed of at least one of the Internet, a local area network, and a leased line;
a telephone, communicating with a remote telephone through a telephone network, receiving a second voice signal from the remote telephone;
a telephone receiver, receiving a third voice signal from the telephone receiver user; and
a shared device, connected to the computer, the telephone, and the telephone receiver, comprising three voice dividers and three mixers, wherein a first voice divider receives the first voice signal from the computer then divides the first voice signal into two first voice divided signals, a second voice divider receives the second voice signal from the telephone then divides the second voice signal into two second voice divided signals, and a third voice divider receives the third voice signal from the telephone receiver then divides the third voice signal into two third voice divided signals, and a first mixer receives and mixes a first and a second voice divided signal then sends the mixed signal to the telephone receiver, a second mixer receives and mixes the other first and a third voice divided signal then sends the mixed signal to the telephone, and a third mixer receives and mixes the other second and the other third voice divided signals then sends the mixed signal to the computer.

20. The multiple communication system according to claim 19, wherein the shared device further comprising:
a first amplifier, disposed between the computer and the first voice divider for amplifying the first voice signal before sending it to the first voice divider;
a second amplifier, disposed between the telephone and the second voice divider for amplifying the second voice signal before sending it to the second voice divider; and
an impedance matcher, disposed between the first amplifier and the computer for adjusting the volume and voice-frequency of the voice signal from the computer according to a differential impedance between the computer and the telephone.

21. The multiple communication system according to claim 19, further comprising a video camera installed in the computer for recording and sending video of the telephone receiver user to the remote Internet client.

22. A multiple communication system, comprising:
a computer, communicating with at least a remote Internet client through network, receiving a first voice signal from the remote Internet client, wherein the communication network composed of at least one of the Internet, a local area network, and a leased line;
a telephone exchange, communicating with a remote telephone through a telephone network, receiving a second voice signal from the remote telephone;
a telephone and telephone receiver thereof, receiving a third voice signal from the telephone receiver user; and
a shared device, connecting the computer, the telephone exchange, and the telephone, comprising a voice divider and a mixer, wherein the voice divider receives the first voice signal from the computer, the second voice signal from the telephone exchange, and the third voice signal from the telephone, and divides the first voice signal into two first voice divided signals, the second voice signal into two second voice divided signals, and the third voice signal into two third voice divided signals, and the mixer receives the voice divided signals, mixes a first and a second voice divided signal then sends the mixed signal to the telephone and the telephone receiver, mixes the other first and a third voice divided signal then sends the mixed signal to the telephone exchange, and mixes the other second and the other third voice divided signals then sends the mixed signal to the computer.

23. The multiple communication system according to claim 22, wherein the shared device further comprising:
a first amplifier, disposed between the computer and the voice divider for amplifying the first voice signal before sending it to the voice divider;
a second amplifier, disposed between the telephone exchange and the voice divider for amplifying the second voice signal before sending it to the voice divider; and
an impedance matcher, disposed between the first amplifier and the computer for adjusting the volume and voice-frequency of the voice signal from the computer according to a differential impedance between the computer and the telephone.

24. The multiple communication system according to claim 23, further comprising a video camera installed in the computer for recording and sending video of the telephone receiver user to the remote Internet client.

25. A multiple communication method, comprising the step of:
providing a computer for communication with at least a remote Internet client through a communication network, wherein the communication network comprises at least one of an Internet connection, a local area network, and a leased line;
providing a telephone for communicating with a remote telephone used by a remote telephone user through a telephone network;
providing a telephone receiver for being used by the telephone receiver user; and
providing a shared device for connecting to the computer, the telephone, and the telephone receiver, wherein the shared device comprises a voice divider and a mixer for receiving voice signals from three parties: the remote Internet client, the remote telephone user, and the telephone receiver user, then mixing the voice signals from any two parties and transmitting to the third party in order to establish multiple communication connection between the remote Internet client, the remote telephone, and the telephone receiver user.

26. The multiple communication method according to claim 25, further comprising
providing a first amplifier disposed between the computer and the voice divider for amplifying the first voice signal before sending it to the voice divider;
providing a second amplifier disposed between the telephone and the voice divider for amplifying the second voice signal before sending it to the voice divider; and
providing an impedance matcher disposed between the first amplifier and the computer for adjusting the volume and voice-frequency of the voice signal from the computer according to a differential impedance between the computer and the telephone.

27. A multiple communication method, comprising the step of:
providing a computer for communicating with at least one remote Internet client through a communication network, wherein the communication network comprises at least an Internet connection, a local area network, and a leased line;
providing a telephone for communicating with a remote telephone used by a remote telephone user through a telephone network;
providing a telephone receiver for being used by the telephone receiver user; and
providing a shared device for connecting to the computer, the telephone, and the telephone receiver, wherein the shared device comprises three voice dividers and three mixers for receiving voice signals individually from three parties: the remote Internet client, the remote telephone user, and the telephone receiver user, then mixing the voice signals from any two parties and transmitting the mixed signal to the third party in order to establish multiple communication connections between the remote Internet client, the remote telephone user, and the telephone receiver user.

28. The multiple communication method according to claim 27, further comprising
providing a first amplifier disposed between the computer and the first voice divider for amplifying the first voice signal before sending to the voice divider;
providing a second amplifier disposed between the telephone and the second voice divider for amplifying the second voice signal before sending to the voice divider; and
providing an impedance matcher disposed between the first amplifier and the computer for adjusting the volume and voice-frequency of the voice signal from the computer according to a differential impedance between the computer and the telephone.

29. A multiple communication method, comprising the step of:
providing a computer for communication with at least one remote Internet client through a communication network, wherein the communication network comprises at least an Internet connection, a local area network, and a leased line;
providing a telephone exchange for communicating with a remote telephone used by a remote telephone user through a telephone network;
providing a telephone and telephone receiver thereof for being used by the telephone receiver user; and
providing a shared device for connecting the computer, the telephone exchange, and the telephone, wherein the shared device comprises a voice divider and a mixer for receiving voice signals from three parties: the remote Internet client, the remote telephone, and the telephone receiver user, then mixing the voice signals from any two parties and transmitting to the third party in order to establish multiple communication between the remote Internet client, the remote telephone user, and the telephone receiver user.

30. The multiple communication method according to claim 29, further comprising
providing a first amplifier disposed between the computer and the voice divider for amplifying the first voice signal before sending it to the voice divider;
providing a second amplifier disposed between the telephone and the voice divider for amplifying the second voice signal before sending it to the voice divider; and
providing an impedance matcher disposed between the first amplifier and the computer for adjusting the volume and voice-frequency of the voice signal from the computer according to a differential impedance between the computer and the telephone.
